(19) United States
(12) Patent Application Publication
(10) Pub. No.: US 2004/0019527 A1
(43) Pub. Date: Jan. 29, 2004

(54) System for the sale of recorded media through the internet adapted to the acoustic print and replay system set up of the customer

(76) Inventor: Luis Felipe Guglielmucci, Santiago (CL)

Correspondence Address: LUIS FELIPE GUGLIELMUCCI, ENRIQUE BARRENECHEA 3820, MACUL, SANTIAGO, ., CL

(21) Appl. No.: 10/064,534

(22) Filed: Jul. 24, 2002

(51) Int. Cl. G06F 17/60

(52) U.S. Cl. 705/26

(57) ABSTRACT

The invention is a Customer Media Replay System (CMRS) that supports the sale of customized versions of a performing art record, mainly but not limited to music, video and data files. The customization process occurs at the seller's and customer's sides. At the seller's side, CMRS keeps the original multitrack/multimedia records (master records) from which it produces customized versions according to the customer's acoustic profile and/or preferences, and the sale's conditions. At the customer's side, the system creates the customer's acoustic profile based on the customer's reproducer device's capabilities and the environmental acoustic characteristics where the music or media files will be replayed.

### OTHER RELATED APPLICATIONS

Referenced-applications

THX DTS

### BACKGROUND OF THE INVENTION

Sources of inspiration

The recorded music is a high technology soundtrack, professionally shaped, mixed, equalized and cleaned. This product goes into the Entertainment Industry where it's promoted, branded and sold. There is also, a House Appliance Industry for recorded music purchase and users that buy the products of both industries.

A brief revision of the Music industry shows us this situation:

Artists are looking to Internet as a much more profitable distribution channel.

The Entertainment Industry is threatened by Internet based copy and distribution software (i.e. Napster), finding harder to protect its copyrights.

The Home Appliances Industry is nailed in the HIFI STEREO paradigm were innovation is coming from fancy designs.

Current paradigms don't allow artists and enterprises, to see that the “Listen to Music Experience” can be improved with the technology already available at a level that obsoletes current solutions, reshaping the entire industry.

### General Industry and Technology Overview

Actual recording technology includes multiples tracks digital recording (32, 64 and over), where one microphone or more are assigned to each instrument obtaining a high fidelity digitally recorded track of each player. The tracks are mixed altogether into 2 separated record channels, RIGHT and LEFT, representing the “Stereo Music”.

The assumption was that reproducing each record trough two high quality speakers, the music's sensation of profundity and volume would be reproduced. What hamper this technique are the multiple uncontrolled sound's reflections and attenuations that occurs at the reproduction site.

In order to reproduce music resembling accurately the site and atmosphere in which it was created, we need to deal with unlimited diverse reproductions sites.

Three facts support this invention:

There are no technological barriers that prevent music vendors to successfully deal with unlimited unique reproduction sites and multichannel music records.

Music vendors will produce unique versions for each customer's reproduction setup, creating barriers to the copyright infringement.

The art market and human nature have proven that the willingness to pay for an art manifestation is strongly correlated with its originality.

### BRIEF SUMMARY OF THE INVENTION

The invention is a system for the sale of recorded media (Customer Media Replay System or CMRS) through the Internet, customized to fit the customer's preferences and acoustic print and replay system's setup, the listening environment's acoustic characteristics and the sale's terms and conditions, comprising the recording, storage and sale of music and related performing arts (video clips, images, computer files, etc.).

CMRS requires access to Internet, storage capacity for music files, multi-channel reproduction capability (a channel for each speaker available), an application or embedded capabilities to determine: the customer's preferences regarding music and related media experience and the acoustic characteristic of user's environment.

### BRIEF DESCRIPTION OF DRAWINGS

FIG. 1 presents a comparison between the current approach and the proposed system (CMRS).

FIG. 2 depicts the architecture of the proposed system at the vendor side.

### DETAILED DESCRIPTION OF THE INVENTION

### Preferred Embodiment

CONTENT PROVIDER and/or SELLER MASTER RECORDS DATA BASE

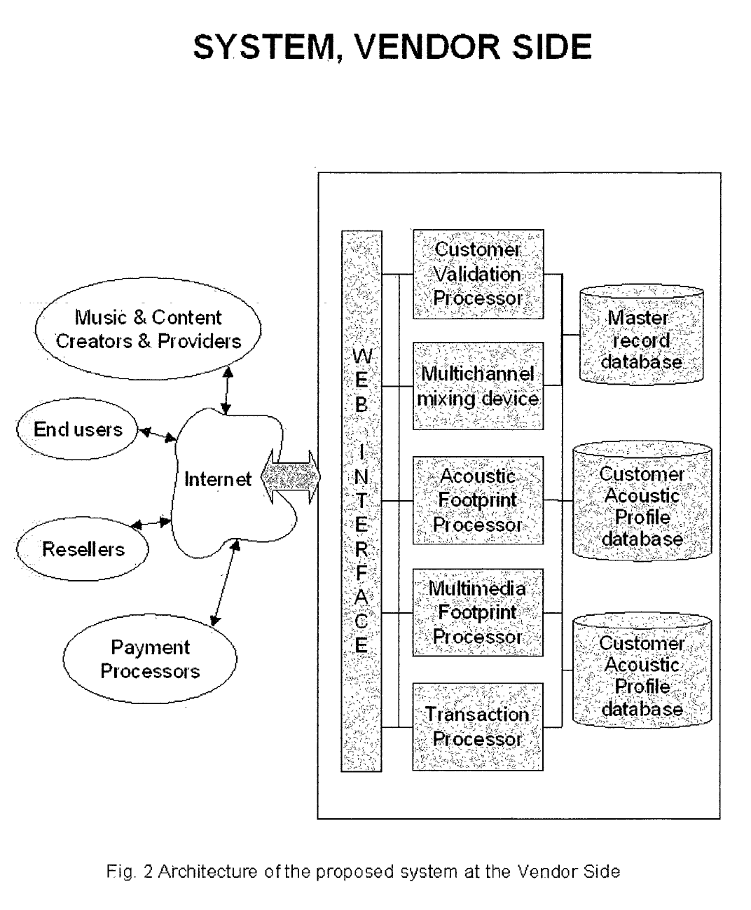

The content provider and or seller database (Original Master Record or OMR) is an organized file of master sound tracks, videos and related data files (FIG. 2).

CONTENT PROVIDER and/or SELLER APPLICATIONS

On top of commercially available e-commerce tools the seller should have an application able to produce a CMRF (Customized Multichannel Recording File). The CMRF will be transferred to the user's reproducing device through internet and will be automatically created by CMRS considering (FIG. 2).

Customer's purchased option (Customer DB).

Customer's reproducer's characteristics: available channels, speakers' type, available storage space, etc. (Customer Acoustic Profile DB).

Customer's listening site's acoustic characteristics (Customer Acoustic Profile database).

The Original Master Record DB.

Main processes involved are: Customer validation and transactions recording, customer's acoustic and multimedia footprint tailoring and customer's multichannel mixing device tailoring.

CONTENT PROVIDER and/or SELLER WEB INTERFACE

The preferred way to support the seller—customers' interactions and relationships is a commercial web site. Other set ups as call centers or physical stores also could be part of the chain (FIG. 2).

CUSTOMER REPRODUCTION DEVICE

The reproduction function at the customer site could be supported in a PC or in a stand-alone device. In both cases the reproduction device will support:

Multiple attached speakers' control.

Environment's acoustic characteristics determination functions.

Multichannel sound tracks storage and reproduction.

Search and structured storage functions.

Reproduction's characteristics control: volume, reverberation, echo, tone, etc.

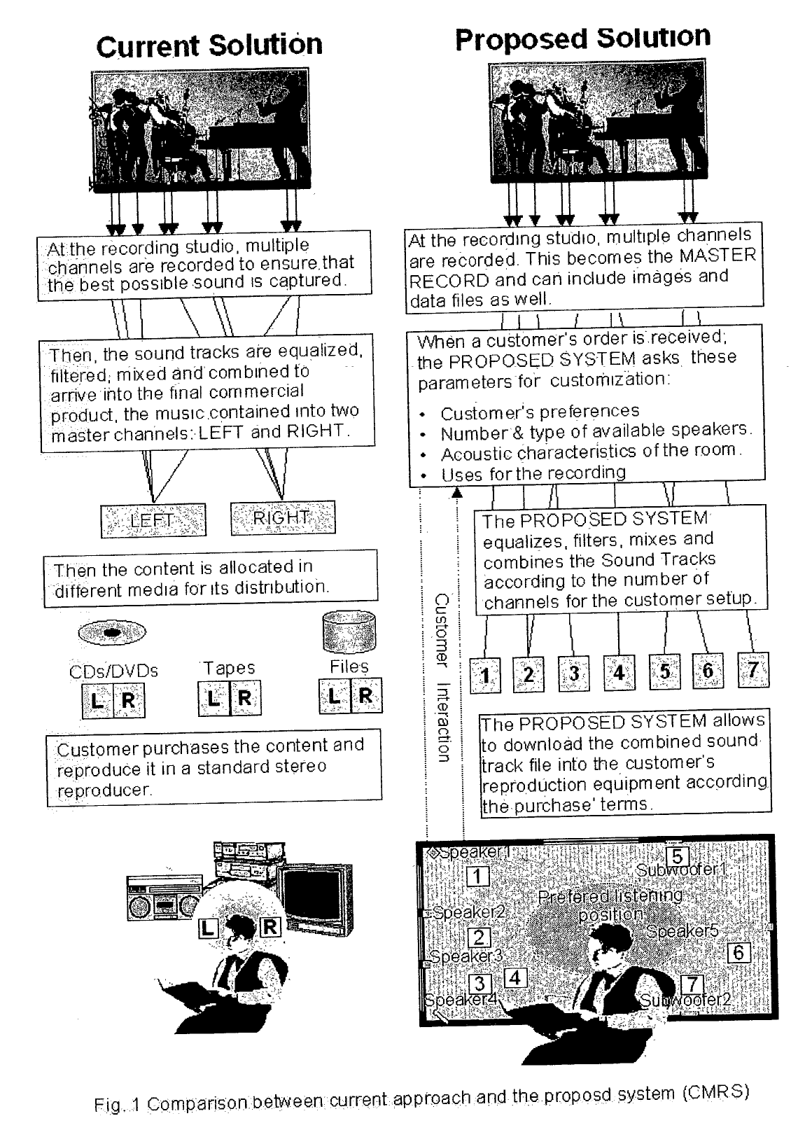

The speakers could be specialized, i.e. woods or drums or bronzes according the end user preferences or general purpose FIG. 1.

### Conceptual Model

The innovations proposed are in brief explained in FIG. 1 “Comparative Systems Solutions”. In the proposed system the product is different, is comprised of a variable number of soundtracks that has been adjusted according the customer profile. The product has been created based on an interaction between the seller and the customer where the customer has provided a profile to generate the product.

### Invention Benefits

END USER EXPERIENCE ENHANCEMENT

Music and related industry (broadcast, storage, etc.) currently follow a massive approach, where a 2-channel version from a multichannel original recording is sold. This invention aims to expand the audio channels to as many as the customer's reproducer system could support, tailoring the record to his or her environmental acoustic characteristics.

PURCHASING OPTIONS AND ARTISTS OFFERINGS EXPANSION

The CMRF opens a lot of new options to purchasers and sellers:

Sale/Purchase the rights to a limited or unlimited system profile adaptations according customers' reproduction system improvements.

Sale/Purchase a package of music to be used once at a party or event.

Sale/Purchase versions for Karaoke of voices or “Instruments” (authors could include partitures and tips for difficult passages).

Sale/Purchase limited amount version's rights, keeping at the seller's site the key file to be played on-line to obtain a coherent reproduction.

Sale/Purchase different quality levels.

Sale/Purchase versions for different devices (cellular phones, PDAs, car

audio systems, etc.), derived from the customer edited CMRF. CMRS supports different business models allowing sellers to control the original master records, and users to keep customized copies. The proposal allows new customers' interactions (i.e. customers can propose his own version for certain channels of the recording) and new ways to increase his or her loyalty and the product's life cycle.

PIRATE DISTRIBUTION OF COPYRIGHTS MATERIALS RESTRICTION

As customer's preferences, reproducer systems and environmental acoustic characteristics generates uniques CMRFs, the invention hinders piracy by:

Offering quality versions differentiated from unauthorized copies.

Limiting the access to the original records.

Sharped price discrimination through quality levels, according purchaser's willingness to pay.

Increasing customer interaction and loyalty.

### Commercial Technology to Support the Invention

The technologies that support this invention are not being integrated in a commercial available product. Examining the different processes that the invented system supports we obtain:

ORIGINAL RECORDING PROCESS. In general all the technology is available and in commercial use.

CREATION OF CMRFs. The software needs to be created and supported on currently available commercial hardware and software.

INTERNET BASED BUSINESS MODEL SUPPORT. The business rules needs to be created and supported on currently available commercial hardware and software.

MULTICHANNEL STORAGE AND REPRODUCTION SYSTEMS CONNECTED TO INTERNET. Currently available audio and computer technology needs to be integrated to create this type of devices. Also the acoustic print determination function must be incorporated in this device.

SPECIALIZED SPEAKERS. Most of the technology is available.

### Similar Business Model or Supporting Technologies in the Market

Up to my current knowledge the audio reproducing technologies that could have some similarities with the ones required to support CMRFs are DTS (Digital Sound System) developed by Lucas Art and focused on movie sound reproduction at the cinema and THX with similar scope.

What is claimed is:

1. What I claim as my invention is a SYSTEM that will support the method of sale to a customer a version of a performing art record, mainly but no limited to music, video and data files, that has been derived from a master record and specially customized to fit the customer's reproducer device and acoustic profile of the reproducer's and/or sales conditions and/or customers uses and/or customers preferences.

2. What I claim as my invention is a media reproducing system with the acoustic characteristics of the speakers' environment determination functions, and the capability of allow multichannel sound tracks storage and reproduction with or without on line support from the vendor's system.
